(19) United States
(12) Patent Application Publication
(10) Pub. No.: US 2002/0143959 A1
(43) Pub. Date: Oct. 3, 2002

(54) Method and apparatus for interactive direct peer-to-peer multimedia streaming

(76) Inventors: David El-Baze, Netanya (IL); Dov Shaham, Guney-Yehuda (IL); Joshua Maor, Ramat-Gan (IL); Haim Leeran, Tel-Aviv (IL); Shay Ben Dov, Tel-Aviv (IL)

Correspondence Address: Rashida A. Karmali, Esq., 99 Wall Street, New York, NY, 10005, US

(21) Appl. No.: 09/824,971

(22) Filed: Apr. 3, 2001

(51) Int. Cl. G06F 15/16

(52) U.S. Cl. 709/228

(57) ABSTRACT

The present invention provides a method and apparatus for an interactive, peer-to-peer, multimedia streaming link to be setup in real-time between two or more remote computing devices, over communication network channels with network addresses, which may be either permanent or temporary. Each computing device is further equipped with an encoder, streaming transmitter, a player and network interface control unit to send and/or accept requests. An interactive peer-to-peer multimedia streaming session is established in real-time by a request from the source-computing device through a control channel, over the network, to a switching service to setup a direct link with a destination-computing device. The switching server than notifies the destination device about the request, and wait for its' acceptance. The switching service than determines the network address associated with either the source device or the destination computing device and the data ports that the peer-to-peer streaming will take place through. Then using the network addresses and the data ports of both computing devices, a real-time, peer-to-peer multimedia streaming system between the source computing device and the destination computing device is setup over the network channel.

### FIELD OF INVENTION

The present invention relates generally to multimedia content streaming from one computing device to another, and more particularly to setup a peer-to-peer link for an interactive multimedia streaming, in real-time, between computing devices without a streaming server in between using dynamic or permanent network addresses capable of accessing a network channel and setup a direct link.

### BACKGROUND OF THE INVENTION

The Internet or any (IP) protocol network provides the means for establishing a communication channel between two or more remote computers. The encoder, streaming transmitter, player and network control interface components enable the capability of an interactive multimedia streaming application. Combining the means of the Internet or IP network together with the capabilities of the computing device enables two or more computing devices to carryout an interactive, peer-to-peer, multimedia streaming in real-time. A peer-to-peer or point-to-point link over an IP network allows the setup of multiple virtual channels directly between the computing devices, which allows them to transport large titles of audio and video content in a continuous streaming mode. However, to setup an interactive real-time peer-to-peer multimedia streaming between two or more computing devices is a cumbersome process.

Generally, a peer-to-peer streaming process is carried out by a two stage operation. First, users have to prepare the content on their computers and encode it in a streaming format, i.e., to prepare the content for transmission and then load it on a streaming server. The second stage involves the remote computing device that has to access the streaming server and request to initiate a process of content transmission in a streaming format between the server and the receiver of the remote computing device. In addition to the difficulty derived from involving three separate software modules that in most cases are implemented in distinct computing devices (that can be located in different sites across the network), another problem is that there is no interactivity in the process. Even though the two users are online through computing devices connected concurrently to the network, there is not interaction between them because their devices are not exchanging information directly, but through the streaming server.

The difficulty in establishing an interactive, peer-to-peer, multimedia streaming between two remote computing devices stems from the following factors among others:

Using separate software modules for content streaming encoding and decoding.

Using a connecting server and a specialized software module for the streaming content transmission.

Establishing the connection between the two computing devices by obtaining their network addresses for direct exchange of information between them.

Thus, in order to achieve maximum interactivity of the peer-to-peer streaming, the method and process should work on any networking scheme. For example, from dial-up, to broadband Internet links, and through local and wide area networks channels. Furthermore, the method and process should support either dynamically assigned addresses or allocated fixed network addresses.

Current Internet infrastructure and especially broadband access methods like cable-mode or ADSL connection, enable the user to exchange and transfer large amount of information in between two remote computing devices, and exploits the possibilities of avoiding the excessive costs of high bandwidth specialized links. Therefore, in order to provide an easy-to-use interactive multimedia streaming system between two computing devices, two problems should be overcome. The first is, establishing a peer-to-peer connection in a simple way across IP based networks. The second is, providing the tools and the means to interactively transfer multimedia content titles in real-time without the need to utilize a dedicated streaming server as mediator between the two remote computing devices.

In practice, there is a need for a simple, automated method and apparatus for setting up an interactive peer-to-peer multimedia streaming system between remote computing devices over the Internet or other network channels. Therefore, by setting up an interactive peer- to-peer multimedia-streaming link, the user can overcome a number of problems including: dynamic allocation of network addresses, temporary links, and handling multiple channels between two or more remote computing devices for concurrent transmission and receiving. The present invention provides a system in which the originating computing device initiates a request to locate the receiving device. Once it gets its' network address, the device starts establishing a transmission stream link to the receiver end. The receiving computing device in turn, listens in a monitor port, and once it gets the request it acknowledges it, then it. Then the receiving computing device opens the receiver and in parallel establishes a transmission stream link to the originator computing device receiver. It is the aim of this invention to provide a system to establish an interactive, peer-to-peer, multimedia streaming link with minimal intervention by the remote user of the receiving computing device. It is also an aim of the present invention to exploit the link between the two computing devices for a setup of a two-way, full-duplex and interactive exchange of streaming content.

### SUMMARY OF THE INVENTION

The present invention is a computing device implemented method of establishing an interactive, peer-to-peer, multimedia streaming link between two or more remote computing devices over a network channel. The present invention also provides a network channel to exploit the available bandwidth of the link, for a two-way full duplex streaming content exchange.

The invention provides an originating computing device which initiates a request to the receiving computing device through its' listening port to stream multimedia content. Once the receiving computing device receives the request on the listening port, it opens a receiver and obtains the originating computing device network address and the port number to listen to. Upon receiving the originator network address and the port number to listen, the receiving computing device establishes a link channel with the originating computing device. The receiving computing device then instructs it to initiate the streaming process.

In addition, the receiving end in the present invention may request to establish a link with the originating computing device on a different port, at the same network address, with an open receiver to get streaming content.

In the present invention, the capability to open multiple channels between two or more computing devices enables the system to implement a two-way full-duplex streaming communication. Utilizing the network addresses of the originating device and at the receiving end, a two-way, full-duplex, peer-to-peer streaming between the originating and receiving computing devices is established, over two or more network channels.

In another embodiment, the present invention provides apparatus comprising, of different hardware configurations for the originating and receiving computing devices, with respect to the network streaming channels. The configurations may be accommodated by this method for establishing the interactive peer-to-peer multimedia streaming link.

In addition, the systems of the present invention allow both ends, and establishing streaming may be initiated by either computing device. These tasks may be executed with or without the use of a network address location service.

The invention also provides an apparatus for supporting and performing an interactive peer-to-peer multimedia streaming over network channels. Specifically, the apparatus includes:

Capture modules for input signal feed from microphone, camera or computer file.

RTP Processor to convert the captured signal to RTP streaming format.

Session Manager that handles the communication between two or more computing devices and which includes:

Request initiation.

Control channel for link establishment.

Channel Communicator for transmitting and receiving operation on two channels.

Socket control.

A player to display and/or play the incoming streaming signal.

The request initiation sub-module is coupled with the link establishment sub-module to activate the channel communication between the remote computing devices. The request initiation sub-module holds the network address of the originating computing device and obtains also the network address of the remote computing device after the acknowledgement of the request by the other end.

The link establishment is coupled with the channel communicator by traversing the network addresses of the computing devices to the channel communicator and maintaining the status of the channels.

The channel communicator holds memory buffers for the transmitted signal coming from the RTP processor and for the received signal coming from the communication line.

The Player is coupled to the channel communicator for the purpose presenting the incoming streaming signal to multimedia kit of the computing device for display on the monitor and/or passes it through the embedded sound system.

### BRIEF DESCRIPTION OF THE DRAWINGS

The advantages and features of the present invention will become readily apparent after reading the following detailed description and referencing the drawings, which are:

FIG. 1 is a diagram showing the process principle and stages of interactive peer-to-peer multimedia streaming on an IP network.

FIG. 2 is a diagram showing the configuration for computing devices to carryout an interactive, peer-to-peer, two-way, Full-Duplex, multimedia streaming, without a streaming server across two network channels.

FIG. 3 illustrates the computing device system components of the apparatus in this invention to carryout peer-to-peer multimedia streaming.

FIG. 4 illustrates the computing devices systems components of the apparatus in this invention to carryout two-way, peer-to-peer, multimedia streaming without a server.

FIG. 5 illustrates the system components and the information flow of the computing device session manager for peer-to-peer multimedia streaming.

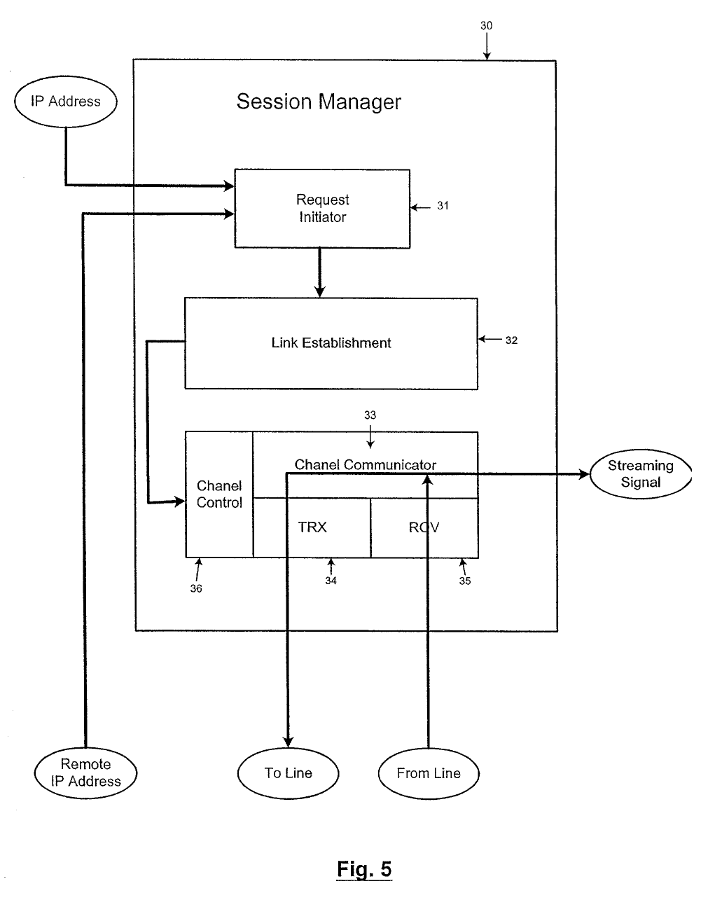

FIG. 6 is a functional diagram showing the steps for establishing peer-to-peer multimedia streaming between two computing devices on a network.

FIG. 7 is a flow chart, which shows the steps for setting up a peer-to-peer multimedia streaming for the originating computing device for sending streaming content in the current invention.

FIG. 8 is a flow chart, which shows the steps for setting a peer-to-peer multimedia streaming for a receiving computing device for receiving the streaming content in the current invention.

### DETAILED DESCRIPTION OF THE PREFERRED EMBODIMENTS

The following description of the preferred embodiment is only exemplary in its' purpose and is in no way intended to limit the invention or its' application or its' uses.

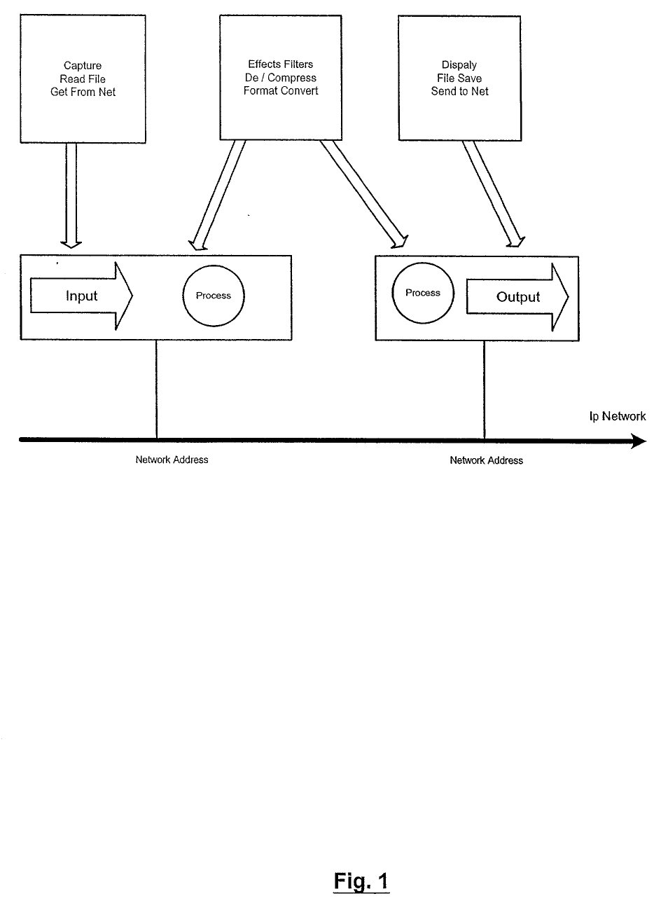

FIG. 1 describes the principle of peer-to-peer multimedia streaming and lays out the setup of modules and the actions involved. The process between two computing units with network addresses on an IP network requires:

An input, from one of the following sources: live capture from a microphone or video camera, a file of multimedia content or a transmission from the net.

A processing operation that involves: applying effects' filter, compression and decompression of the content, format conversion and transmission.

An output to one of the following destinations: a display or loudspeakers, a file for saving or re-transmission over the net.

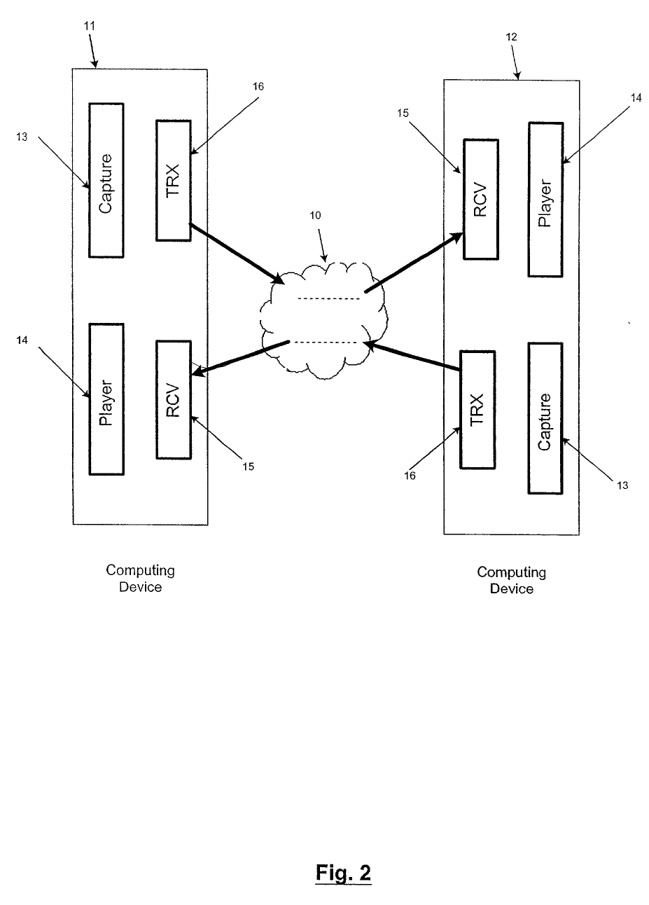

FIG. 2 shows the required system components to setup an interactive, peer-to-peer, two-way, full-duplex multimedia streaming across a network channel 10. In the present invention, the Internet is used as a network channel 10. The Internet is a collection of inter-connected networks with different topologies, configurations and infrastructure that use primarily TCP or UPD over IP protocols to communicate and packet switching media to exchange information.

Remote computing devices that can be Desktop PC, Notebooks, PDA or Hand Pocket PC, Internet Appliance or TV Set-Top Box use the network to set up streaming links. A remote computing device can access the network channel in different ways:

Physical direct connection, wireless attachment or through a local area network.

With a permanent or dynamically assigned network address.

Over dial-up phone links, packet-switched network or dedicated communication lines.

The computing device 11 or 12 in the current invention provides the following basic system components to support two-way full-duplex peer-to-peer multimedia streaming:

Capture for input the content signal 13.

Player to present or save the output content signal 14.

TRX transmission unit to send the streaming signal 15.

RCV a receiver to intercept and receive the streaming signal 16.

To achieve the two-way peer-to-peer streaming of the present invention, the computing devices communicates directly between them on two separate network channels 10 where the transmission unit 16 of one communicate with the receiver 15 of the other computing device and vice versus.

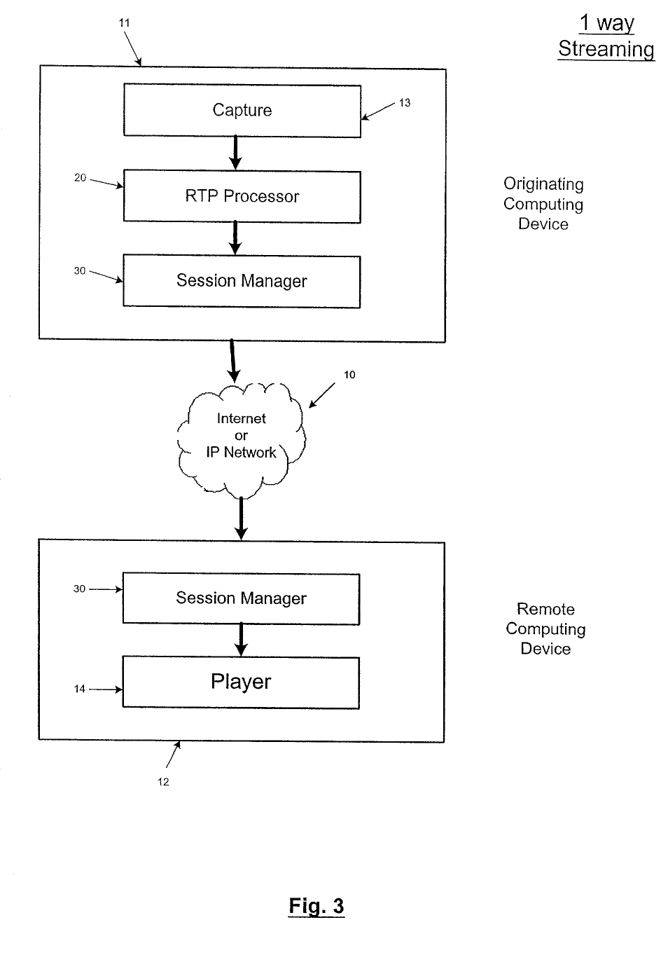

FIG. 3 illustrates the apparatus modules of the current invention that support a one-way, half-duplex, peer-to-peer, multimedia streaming across a network channel 10. The apparatus contains the two basic components: the originating computing device 11 and the remote receiving computing device 12.

The originating computing device 11 contains the following system components:

Capture for input the content signal 13.

RTP Processor to convert from signal own format to the streaming transmission format 20.

Session Manager 30 to handle the communication dialogue and the content streaming transmission to the remote computing device 12.

The remote receiving computing device 12 contains the following system components:

Player to output the content signal on a display or save in a file 14.

Session Manager 30 to handle the communication dialogue and the content streaming signal receiving from the originating computing device 11.

The direct peer-to-peer multimedia streaming is achieved by establishing a link, dialogue, and communication channel between two or more computing devices. Specifically, the signal transfers in the originating unit 11 from the capture module 13 through the RTP Processor 20 for format conversion. The signal then transfers to the Session Manager 30 and across the Internet 10 to the receiving remote unit 12 housing the Session Manager, and finally to the system Player 14 for the content presentation.

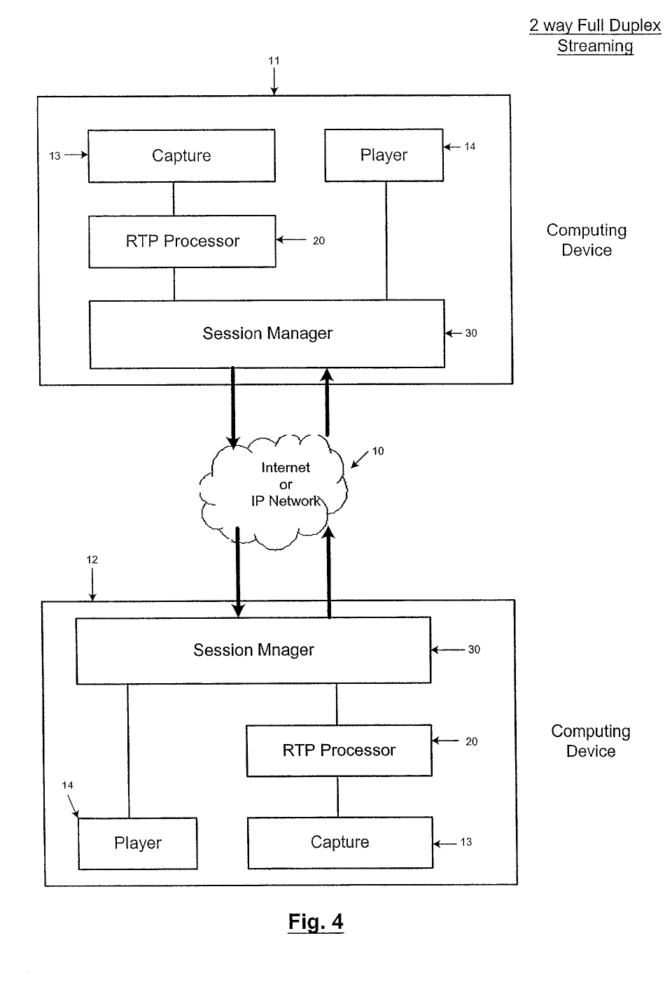

FIG. 4 illustrates the apparatus modules of the current invention that support a two-way, full-duplex, peer-to-peer, multimedia streaming across two network channels 10. The apparatus contains the basic components: the originating computing device 11 and the remote receiving computing device 12.

The originating computing device 11 contains the following system components:

Capture for input the content signal 13.

Player to output the content signal on a display or save in a file 14.

RTP Processor to convert from signal own format to the streaming transmission format 20.

Session Manager 30 to handle the communication dialogue and the content streaming transmission to the remote computing device 12.

The remote receiving computing device 12 contains the following system components:

Capture for input the content signal 13.

Player to output the content signal on a display or save in a file 14.

RTP Processor to convert from signal own format to the streaming transmission format 20.

Session Manager 30 to handle the communication dialogue and the content streaming signal receiving from the originating computing device 11.

The direct, two-way, full-duplex, peer-to-peer multimedia streaming is achieved by establishing a link, dialogue and two communication channels between two or more computing devices. One streaming signal traverse in the originating unit 11 from the capture module 13 through the RTP Processor 20 for format conversion to the Session Manager 30. It then traverses across the Internet 10 to the receiving remote unit housing the 12 Session Manager and finally to the system Player 14 for the content presentation.

In parallel, a second signal is streamed from the remote computing device 12 toward the originating unit 11 in the same manner. The two-way, full-duplex, peer-to-peer multimedia streaming of the invention, enables to carryout an interactive session with live conversation and video capture in both sides of the connection.

FIG. 3 illustrates the sub-components of the Session Manager 30 module in the apparatus of the current invention. The Session Manager 30 is responsible for creating the communication link with remote computing device, handling the dialogue between the two remote units and controlling the actual streaming process with the following sub-components:

streaming Request Initiator 31.

Link Establishment Unit 32.

Channel Communicator 33.

TRX transmission unit 34.

RCV receiver unit 35

Channel Control 36.

The Session Manager is the main component to realize the direct peer-to-peer multimedia streaming without having a server between two or more computing device.

The Request Initiator 31 gets a request from the application program to initiate a streaming signal process, the IP address of the originating computing device 11 and the target remote computing device. Its' role is to obtain the IP address of the remote computing device 12. Upon determining the net addresses of the computing devices, it passes an instruction to the Link Establishment module 32 for a channel setup, that in turn passes the network addresses to the Channel Control module 36.

The Channel Communicator 33 gets the streaming signal from the RTP Processor 20 and passes it to the TRX transmission unit 34 that transfers it to the line with the network address of the remote computing device. The network address is received from the Channel Control, 36 that supervises the flow of the streaming process.

In a receiving mode the RCV receiver unit 34 gets from the Channel Control 36 a remote computing device network address to intercept the streaming signal. The RCV transfers from the communication, line the signal's content to the Channel Communicator 35 buffer. From there, the Session Manager 30 passes the accumulated content to the system Player 14.

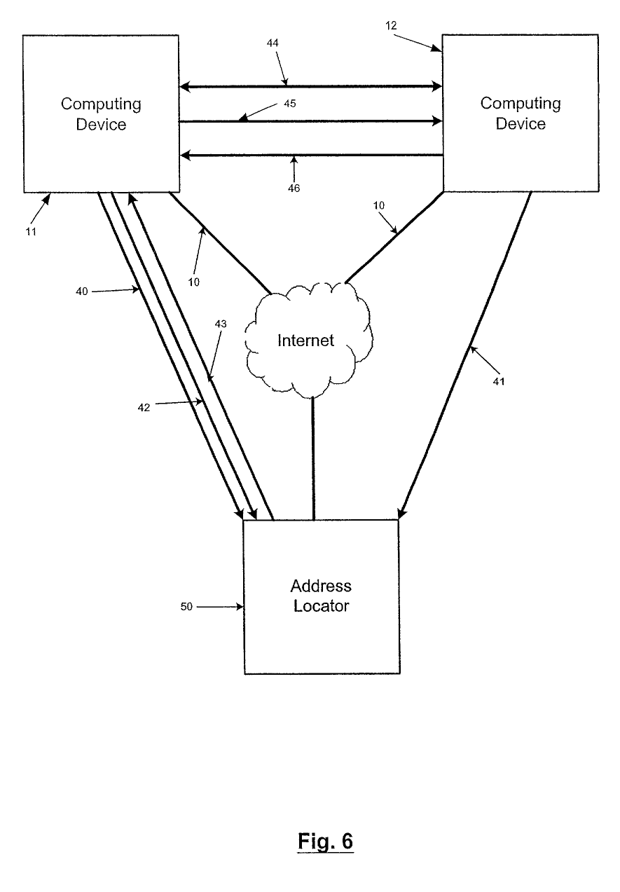

FIG. 6 shows a functional diagram of the steps for setting a two-way, full-duplex, peer-to-peer, multimedia streaming session using Address Locator 50 service. Both computing devices are connecting to the Internet 10 either with permanent or dynamically allocated addresses.

The originating computing device 11 is logged onto an Address Locator 50 and updating its' network address 40. The remote computing device 12 does the same steps of updating the Address Locator 50 with the network address 41. Once the update is done the computing devices are in a receive mode.

The originating computing unit 11 starts the process of a peer-to-peer streaming toward the remote receiving unit by issuing a request 42 to the Address Locator 50 to obtain the network address 43 of the receiving remote computing device 12. Once the network address of the receiving computing device 12 is known to the originating one 11 it issues a request 44 to the receiving device 12 to enter in a receive mode and be ready to intercept the streaming signal.

In addition the network address of the originating computing device 11 is transferred to the remote receiving unit 12. The receiving unit 12 acknowledges the request 44 and instructs back the originating unit to also enter to a receiving mode. Upon receiving the acknowledgement from the remote unit 12 the originating unit starts the streaming 45 on the communication channels that was established between the computing devices.

The receiving unit 12 may optionally send streaming content 46 back to the originating unit on a second channel established between the computing devices. In the current invention the streaming process takes places directly between the computing devices where each is equipped with a transmitter and receiver. Therefore, the streaming exchange is done on two network communication channels. The result is an interactive, two-way, full-duplex, peer-to-peer, multimedia streaming without the involvement or utilization of streaming server.

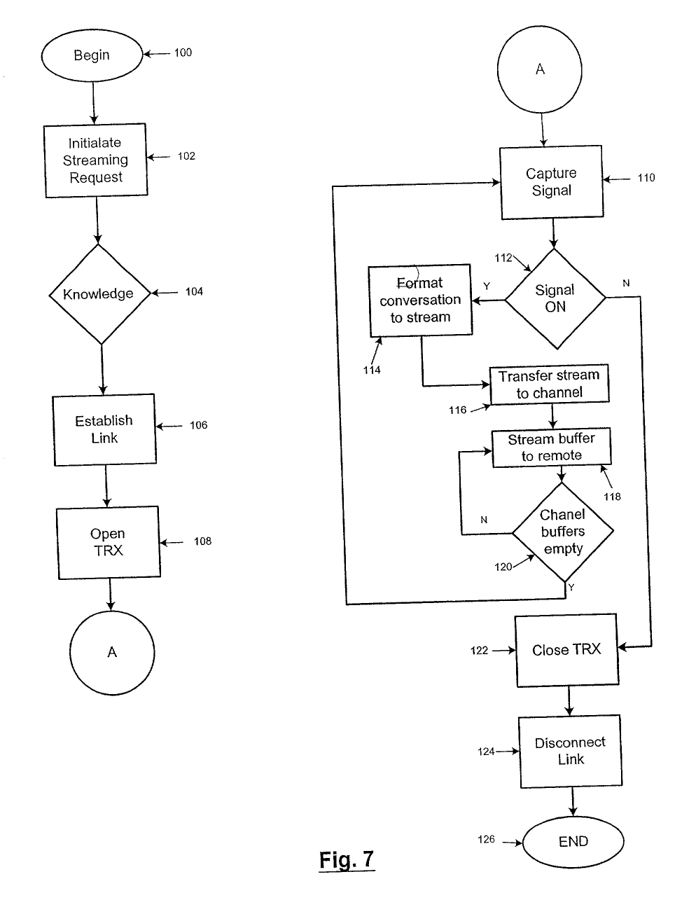

FIG. 7 is flowchart depicting an embodiment of the procedures encapsulated in the originating computing device 11 in the present invention. For the preferred embodiment the user of the originating computing device indicates a remote computing device 12 for setting up a peer-to-peer multimedia streaming link. In this embodiment it is assumed that the originating and receiving computing devices are connected to an IP network either with permanent or dynamically assigned network addresses. The originating computing device 11 address can be obtained either by the user or by the application program. The remote computing device's 12 network address can be supplied by the user at the originating side or can be supplied by an Address Locator 50 service.

Start Block 100 signifies the start of the peer-to-peer multimedia streaming send operation and begins with an initiate streaming request 102 where the request is transmitted to the remote computing device 12 with all the parameters that are required including: network addresses, ports to transmit and listen, type of the content like MP3 music, Video clip or live audio and video. The originating computing 11 device gets an acknowledgment 104 from the remote computing device 12 and establishes a link 106 and opens the transmitter 108.

At block 110 Capture Signal—the content is fed to the system either from a live source like microphone or video cam and/or from a file that stores multimedia title.

In block 112—Signal On the apparatus is checking if the feeding goes on. Upon receiving the signal it is transferred to the RTP Processor for format conversion 114 to streaming transmission protocol. After the format conversion the streaming content is passed to the channel communicator 116 buffers.

From the channel communicator the streaming media is received by the remote computing device which takes place according to the setup of the link by the transmission unit 118. In parallel a check is carried out to detect 120 that the channel buffers are empty. As long as there is a continuous feed of content signal, the streaming goes on. An interrupt in the capture process signals the apparatus of the current invention to close the transmission unit 122, signal the remote computing device on end-of-streaming and disconnect the link. The END block 126 signifies the end of the streaming request.

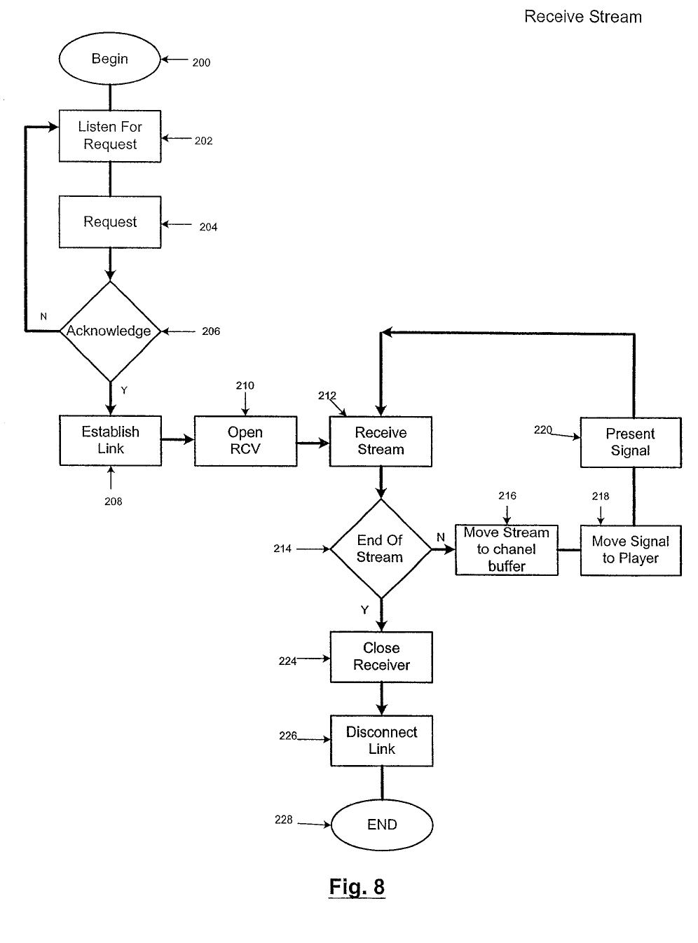

FIG. 8 is flowchart depicting an embodiment of the procedures encapsulated in the remote receiving computing device 12 of the present invention. For the preferred embodiment the user of the remote receiving device indicates that he is in a listening status to get a request for peer-to-peer multimedia streaming from the originating computing device. In this embodiment it is assumed that the originating and receiving computing devices are connected to an IP network either with a permanent address or dynamically assigned network addresses.

The receiving computing device 12 address can be obtained either by the user or by the application program. The originating computing device 11 address can be supplied by the user at the receiving end or can be supplied by the originating side as part of the “Request to Stream Initiation Parameters”.

Start Block 200 signifies the start of the peer-to-peer streaming stand-by situation to intercept an originator request by entering into a listen for request mode 202. Upon intercepting a request the remote receiving computing device processes it 204, gets all the parameters like the originating address, type of content and the port to listen, and acknowledges it 206 by sending back its' address and the port that the originating side should listen.

After the acknowledgement the receiving device establishes the communication link 208 and opens the receiver unit 210 to receive a stream of multimedia content from the communication line 212. The first check that is carried-out is to detect end of streaming request signal 214. If the streaming process continues the content is transferred to the communication channel 216 buffers. From the communication channel buffer the content is transferred to the receiving computing device player 218 to be presented by the apparatus of the current invention 220 via loudspeakers and/or monitor, or to be saved in a computer storage file.

Detecting end of stream request signal 214 instructs the receiving unit to close its' receiver and disconnect the communication link 226 with the originating side. The End Block 228 may signal to the receiving computing device to wait until activation to enter into streaming request interception status.

The foregoing discloses and describes exemplary embodiments of the present invention. A person skilled in the art will readily recognize from such discussion and from the accompanying drawings and claims that various changes, modifications and variations can be made therein without departing from the spirit and the scope of the present invention.

What is claimed:

1. A method of establishing a peer-to-peer communication between an originating computing device and a receiving computing device over a network channel that identified communicating devices without having a streaming server over the network channel, said method comprising the steps of:
sending a message from said originating computing device to said receiving computing device over a first listening port;
opening a receiver and establishing a first network address and a port number of the originating computing device,
generating a link channel with the originating computing device and triggering the streaming process and establishing communication between the originating computer device and the receiving computer device over the network channel using the first network address.

2. The method according to claim 1 further comprising the step of:
establishing a link with the originating computing device over a second listening port.

3. The method according to claim 1 further comprising the step of opening multiple channels between at least two computing devices, and enabling a two-way full duplex streaming communication.

4. The method according to claim 3 wherein one streaming signal traverses in the originating computer device form a capture module through a RTP Processor, the Session Manager, the Internet, the receiving computer device and to the Player for content presentation, and
the second streaming signal flows from a remote computing device to the originating computer device.

5. The method according to claim 1, further comprising the step of connecting the originating computer device and the receiving computer device to an IP network with network addresses, said addresses being permanent or dynamically assigned.

6. The method according to claim 5, further comprising a remote receiving device, wherein the user of the remote receiving device is in a listening status waiting for a request for peer-to-peer multimedia streaming from an originating computer device.

7. An apparatus for supporting an interactive, direct, peer-to-peer multimedia streaming over a network channel, said apparatus comprising:
a capture device for input of a content signal,
a player to present the output content signal,
a format converter,
a TRX transmission unit for sending a streaming signal, and
a RCV receiver to intercept and receive the streaming signal.

8. An apparatus for supporting a one-way, half duplex, peer-to-peer, multimedia streaming across a network channel, said apparatus comprising an originating computing device and a remote receiving computing device, said originating computing device further comprising a capture device, an RTP processor and a Session Manager, and said remove receiving computing device comprising a Player and the Session Manager.

9. The apparatus according to claim 7 further comprising a Session Manager, said Session Manager further comprising of sub-modules including a Streaming Request Initiator, a Link Establishment Unit, a Channel Communicator, a Transmission Unit, a Receiver Unit or a Channel Control.

10. The apparatus according to claim 7, for realizing the direct peer-to-peer multimedia streaming, characterized by the absence of a server between two or more computing devices.
